(19) United States
(12) Patent Application Publication
(10) Pub. No.: US 2011/0116115 A1
(43) Pub. Date: May 19, 2011

(54) IMAGE PROCESSOR AND IMAGE PROCESSING METHOD

(75) Inventors: Norihiro Kawatoko, Yokohama-shi (JP); Hitoshi Nishikori, Inagi-shi (JP); Yutaka Kano, Yokohama-shi (JP); Yuji Konno, Kawasaki-shi (JP); Akitoshi Yamada, Yokohama-shi (JP); Mitsuhiro Ono, Tokyo (JP)

(73) Assignee: CANON KABUSHIKI KAISHA, Tokyo (JP)

(21) Appl. No.: 12/942,718

(22) Filed: Nov. 9, 2010

(30) Foreign Application Priority Data
Nov. 17, 2009 (JP) 2009-261910

(51) Int. Cl. H04N 1/60

(52) U.S. Cl. 358/1.9

(57) ABSTRACT

There are provided an image processing method and an image processor which realize the processing of restricting image degradations such as “dot delay”, “banding” and “wind ripple” with a simpler circuit construction. Therefore, after the regular quantization processing is performed, in a pixel in a prohibition position the processing of limiting a predetermined quantized value to change into another quantized value is performed corresponding to the obtained quantized value and the position information of the pixel of interest. By doing this, even in the low level of the density value, it is possible to realize at a low cost the construction in which dots having different sizes are mixed for printing.

### BACKGROUND OF THE INVENTION

1. Field of the Invention

The present invention relates to an image processor and an image processing method which perform quantization processing based upon image information.

2. Description of the Related Art

A system for printing received image information on a print medium performs processing of quantizing a multi-valued density signal (half-toning) to a density signal having a smaller gradation number. There are known various methods of the quantization processing, and particularly in a case of outputting an image in which greater importance is placed on uniformity as in the case of photos, an error diffusion processing method is generally used as an effective method.

In the error diffusion processing method, a multi-valued density value of a pixel of interest is compared with a predetermined threshold value to determine presence/absence of dot printing, a size of a dot to be printed and the like. In a case of the multi-valued error diffusion processing method of an N-value, (N−1) pieces of threshold values are prepared, each of the threshold values is compared with the density value of the pixel of interest, and a quantum value is determined according to the comparison result. An error between the result of the quantization and an original density signal inputted to the pixel of interest is diffused to adjacent pixels to sequentially proceed with quantization of a new pixel of interest. When such an error diffusion processing method is adopted, even in a printer capable of adjusting a dimension of the dot only in several steps such as large, intermediate and small sizes, a density value corresponding to the input signal can be expressed in a region having some degrees of width on a print medium.

However, in a case where the printer adopting such an error diffusion processing method prints a gradation image in which the density is gradually increased form a low level, there occurs a new problem which is called “dot delay”.

FIG. 1 is a diagram for explaining a phenomenon of “dot delay” taking a highlight portion (low gradation portion) as an example. In the highlight portion, density values which are smaller than a threshold value for determining whether or not a dot is printed and not zero are mostly inputted to many pixels. In consequence, since immediately after starting the processing, there exist pixels each having some levels of the density value a value of which does not exceed the threshold value, the pixels which are determined (quantized) as a dot non-print (0) are successively present. However, by repeating such processing, errors added to the density value D are gradually accumulated and pixels exceeding the threshold value occur over time. After a print of the dot is for the first time determined in such a pixel, dots can be printed by relatively stable intervals even in the same highlight portion.

In this way, many pixels are quantized to a lower level of the density value until the errors are accumulated even in a region having some degrees of the density value, and occurrence of the dot having a high level thereof is delayed. In the present specification, this delay is called “dot delay”. In consequence, “dot delay” is easy to confirm in a density region to the extent that a size of the dot is just changed, such as from small dot to intermediate dot or from intermediate dot to large dot.

In addition, when general error diffusion processing is adopted, dots each having the same size tend to easily collect for expressing a predetermined density value, and an image degradation called “banding” tends to easily stand out.

FIG. 2 is a diagram for explaining the above “banding”. In an inkjet printer, a printing head 102 in which a plurality of print elements 101 ejecting ink are arranged in a line is used to print dots on a print medium. At this time, some of the plurality of the print elements 101 ejects ink in a direction more or less different from that of the other print element. When such a print head 102 is used to uniformly print dots each having the same size, a region 104 where dots overlap more than necessary or a region 105 where blank sheets are exposed more than necessary appears in a line shape as shown in FIG. 2, which creates an image degradation called “banding”.

Further, as use of small-sized droplets is in progress as recently, the number of fine droplets (satellite or mist) inevitably generated in ejecting increases, and the existence of these fine droplets can not be ignored on an image. For example, these fine droplets float between the print head and the print medium, which land on the print medium due to a carriage scan or the like to form a particular pattern called “wind ripple” on the print medium. Since such “wind ripple” appears in no relationship with image data to be printed, it is considered as one of the image degradations.

As described above, in the present situation, the general error diffusion processing method conventionally used can not solve the image degradations such as “dot delay”, “banding”, and “wind ripple”.

For overcoming the above problem, Japanese Patent Laid-Open No. 2004-326613 discloses an error diffusion processing method which can reduce the image degradations caused by the above “dot delay”, “banding” and “wind ripple”. Specifically there is disclosed the image processing method in which error diffusion processing is performed in a predetermined particular pixel position, which is different from that in the other pixel position, to mix dots having different sizes even in an uniform density region for printing.

FIGS. 3A and 3B are flow chart explaining the process of the error diffusion processing in the printer performing a print with three kinds of dots of large, intermediate and small sizes, which is described in Japanese Patent Laid-Open No. 2004-326613. In regard to a pixel, a density signal thereof is received in E01, pixel position information is obtained therefrom in E02, and the density is corrected (addition of errors generated in adjacent pixels) in E03. Thereafter, in E04, by referring to the pixel position information obtained in E02, it is determined whether or not this pixel position is a prohibition position. When it is determined that the pixel position is the prohibition position, the process goes to E25 and when it is determined that it is not the prohibition position, the process goes to E05.

In E05 to E11, general quantization processing (E50) is performed to the pixel which is not in the prohibition position. Herein three threshold values TH1 to TH3 are prepared and the density value D′ corrected in E03 is quantized into four steps of 0 to 3. On the other hand, in E25 to E29, particular quantization processing (E51) prepared for the prohibition position is performed. Herein two threshold values (TH2′ and TH3′) are prepared and the density value D′ corrected in E03 is quantized into three steps of 0, 2 and 3.

When the quantized value is determined in E50 or E51, the process goes to E12, wherein an error between the density value inputted in E01 and an output signal corresponding to the determined quantized value is calculated. Further the process goes to E13, wherein the error obtained in E12 is distributed to adjacent pixels which are not quantized yet, according to a predetermined diffusion coefficient, and the present processing ends.

As a result of performing the error diffusion processing according to the flow chart as described above, the dot is not printed in the pixel where the quantized value is 0, the small dot is printed in the pixel where the quantized value is 1, the intermediate dot is printed in the pixel where the quantized value is 2, and the large dot is printed in the pixel where the quantized value is 3.

As a result of performing the error diffusion processing according to such flow chart, in the region having the density of an uniform low level, the density value is quantized to level 0 or level 1 in the pixel in a position other than the prohibition position and the density value is quantized to level 0 or level 2 in the pixel in the prohibition position. As a result, an entire image becomes in a state where a small number of intermediate dots are printed in places while a relatively large number of small dots are printed in a diffused manner. That is, when the error diffusion processing is performed by adopting Japanese Patent Laid-Open No. 2004-326613, even in the region of the low-level density value, since the dot having a size larger by one step is ahead printed in places, “dot delay” is restricted and as a result the blank portion does not stand out even in the highlight portion.

In addition, in a case where the conventional error diffusion processing is performed, when landing-on positions of one print element are shifted, the banding tends to stand easily out as shown in FIG. 4A, but in a case of adopting the error diffusion processing in Japanese Patent Laid-Open No. 2004-326613, a large degradation does not influence the entire image as shown in FIG. 4B. Further, since use of only small dots where the mist or satellite tends to easily occur is not made in a case of adopting the method in Japanese patent Laid-Open No. 2004-326613, it is also possible to restrict occurrence of “wind ripple”.

However, since the quantization processing in the regular position is different from that in the prohibition position in the error diffusion processing disclosed in Japanese Patent Laid-Open No. 2004-326613 as shown in 550 and 551 of FIG. 3, it is required to prepare two kinds of circuit arrangements for the quantization processing. Further, since the different threshold values are used between the two kinds of the quantization processing, two sets of the threshold values respectively are required to be stored in different regions in the memory. Therefore, adoption of the error diffusion processing method disclosed in Japanese Patent Laid-Open No. 2004-326613 inevitably leads to an increase in costs as compared to the circuit arrangement for the regular error diffusion processing.

### SUMMARY OF THE INVENTION

The present invention is made in view of the foregoing problem and an object of the present invention is to provide an image processing method and an image processor which realize error diffusion processing, in which even in a region having the density value of a low level, dots of plural sizes are mixed for printing, with a simpler circuit arrangement.

The first aspect of the present invention is an image processor for quantizing a density data of L-value of a pixel of interest to a quantized value of K-value (3≦K<L) to print dots on a print medium based upon the quantized value, comprising: a unit configured to obtain the density data of L-value corresponding to the pixel of interest; a unit configured to correct the density data of L-value to a comparison data of L-value using an error diffused from a pixel which is adjacent to the pixel of interest and is already quantized; a unit configured to obtain position information of the pixel of interest; a quantization unit configured to convert the comparison data of L-value into the quantized value of K-value based upon the result by comparison with plural threshold values and generate an output signal of L-value corresponding to the quantized value; a determining unit configured to determine whether or not the quantized value is changed based upon the quantized value and the position information of the pixel of interest; a changing unit configured to, when the determining unit determines to change the quantized value, change the quantized value and change the output signal of L-value corresponding to the changed quantized value; and a unit configured to diffuse an error between the density data of L-value and the output signal of L-value in the pixel of interest to a pixel which is adjacent to the pixel of interest and is not yet converted by the quantization unit.

The second aspect of the present invention is an image processing method for quantizing a density data of L-value of a pixel of interest to a quantized value of K-value (3≦K<L) to print dots on a print medium based upon the quantized value, comprising: a step of obtaining the density data of L-value corresponding to the pixel of interest; a step of correcting the density data of L-value to a comparison data of L-value using an error diffused from a pixel which is adjacent to the pixel of interest and is already quantized; a step of obtaining position information of the pixel of interest; a quantization step of converting the comparison data of L-value into the quantized value of K-value based upon the result by comparison with plural threshold values and generating an output signal of L-value corresponding to the quantized value; a determining step of determining whether or not the quantized value is changed based upon the quantized value and the position information of the pixel of interest; a changing step of, when the determining step determines to change the quantized value, changing the quantized value and changing the output signal of L-value corresponding to the changed quantized value; and a step of diffusing an error between the density data of L-value and the output signal of L-value in the pixel of interest to a pixel which is adjacent to the pixel of interest and is not yet converted by the quantization step.

The above and other objects, effects, features and advantages of the present invention will be become more apparent from the following description of embodiments thereof taken in conjunction with the accompanying drawings.

Further features of the present invention will become apparent from the following description of exemplary embodiments (with reference to the attached drawings).

### BRIEF DESCRIPTION OF THE DRAWINGS

FIG. 1 is a diagram explaining a phenomenon of “dot delay” by taking a highlight portion as an example;

FIG. 2 is a diagram explaining “banding”;

FIG. 3 is a diagram showing the relationship of FIGS. 3A and 3B;

FIG. 3A is a flow chart explaining the process of the error diffusion processing in a printer for printing with three kinds of dots of large, intermediate and small sizes, which is described in Japanese Patent Laid-Open No. 2004-326613;

FIG. 3B is a flow chart explaining the process of the error diffusion processing in a printer for printing with three kinds of dots of large, intermediate and small sizes, which is described in Japanese Patent Laid-Open No. 2004-326613;

FIGS. 4A and 4B are diagrams explaining a mixing state of small and intermediate dots and the likelihood of high visibility of “banding”;

FIGS. 5A and 5B are perspective diagrams explaining an arrangement of a main part of a printing unit in an inkjet printer usable in the present invention and an arrangement of an inkjet printing cartridge installed herein;

FIG. 6 is a schematic block diagram explaining an arrangement of a control system in an image processor applicable to the present invention;

FIG. 7 is a flow chart explaining the process of error diffusion processing performed in Embodiment 1 of the present invention, by comparing with Japanese Patent Laid-Open No. 2004-326613;

FIGS. 8A and 8B are diagrams explaining threshold values prepared in Japanese Patent Laid-Open No. 2004-326613;

FIG. 9 is a diagram showing a pattern defining a prohibition position;

FIG. 10 is a diagram explaining threshold values prepared in Embodiment 1 of the present invention;

FIG. 11 is a flow chart explaining the process of error diffusion processing performed in Embodiment 2 of the present invention;

FIG. 12 is a diagram explaining threshold values prepared in Embodiment 2;

FIG. 13 is a flow chart explaining the process of error diffusion processing performed in Embodiment 3 of the present invention;

FIG. 14 is a diagram showing an arrangement example of prohibition positions;

FIGS. 15A and 15B are diagrams explaining states of a distribution of pixels and a distribution of small dots defined in a quantized value of 1 at the time of gradually increasing the density from a highlight in a case of performing the error diffusion processing with the method of Japanese Patent Laid-Open No. 2004-326613;

FIGS. 16A and 16B are diagrams explaining states of a distribution of pixels and a distribution of small dots defined in a quantized value of 1 at the time of gradually increasing the density from a highlight in a case of performing the error diffusion processing with a method of Embodiment 3;

FIG. 17 is a block diagram explaining the process of error diffusion processing performed in Embodiment 4 of the present invention; and

FIG. 18 is diagrams showing an example applying the present invention to a printing system for associating pixels of 2×2 with one quantized value.

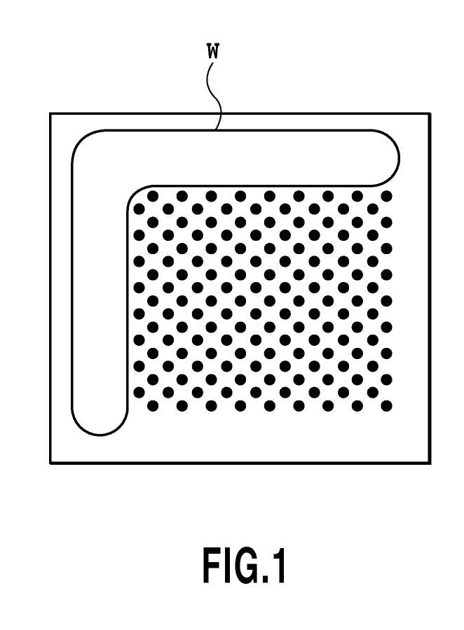

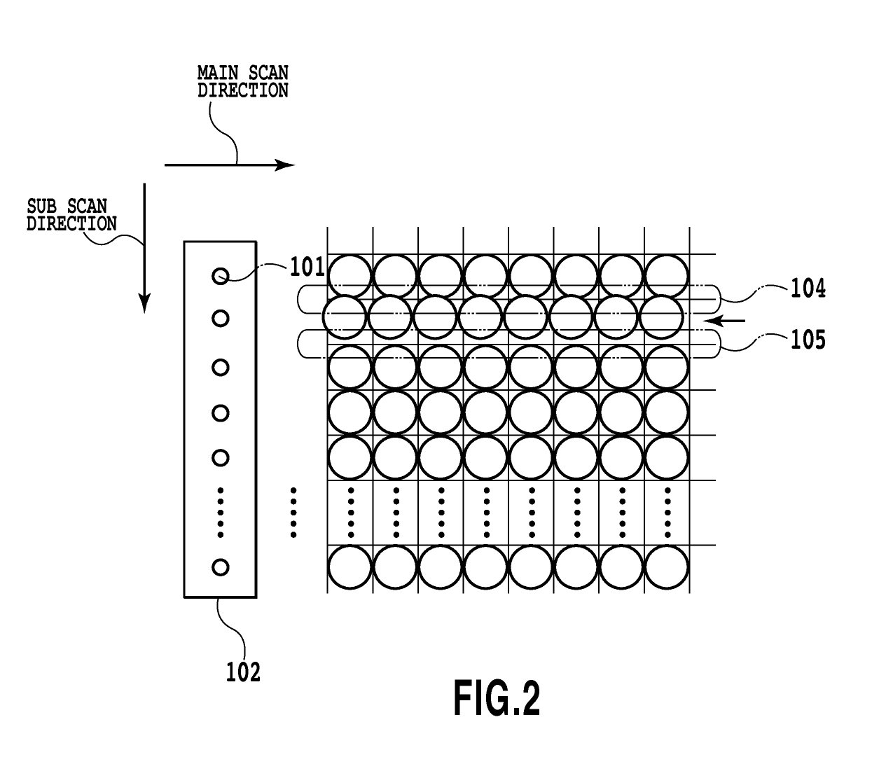

### DESCRIPTION OF THE EMBODIMENTS

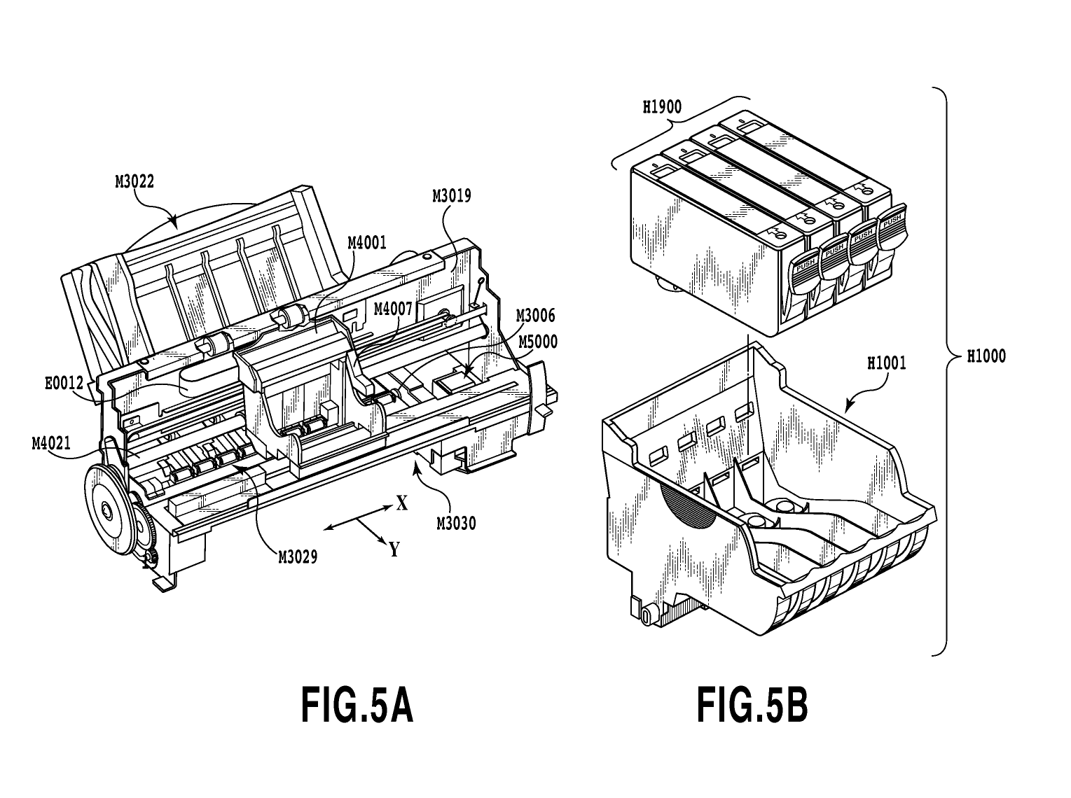

Hereinafter, embodiments of the present invention will be explained with reference to the attached drawings. FIGS. 5A and 5B are perspective diagrams explaining an arrangement of a main part of a printing unit in an inkjet printer usable in the present invention and an arrangement of an inkjet printing cartridge installed herein. By referring to FIG. 5A, a chassis M3019 accommodated inside an outer member of the printer is configured by a plurality of plate-shaped metal members each having a predetermined rigidity to form a skeleton of the printer and holds each mechanism to be explained hereinafter. An automatic feed unit M3022 automatically feeds sheets (print medium) inside the printer body. A conveyance unit M3029 guides sheets fed one by one from the automatic feed unit M3022 to a predetermined print position and also guides the sheet from the print position to a discharge unit M3030. An arrow mark Y is a conveyance direction of sheets (sub scan direction).

A desired print is performed on a sheet conveyed in the print position by a print head cartridge H1000 removably mounted on a carriage M4001. The carriage M4001 moves at a predetermined speed in a main scan direction of an arrow mark X with being supported by a carriage axis M4021 during the printing by the print head cartridge H1000. At this time, the print head cartridge H1000 receives a head drive signal necessary for printing from a main substrate via a flexible cable E0012. A recovery unit M5000 performs maintenance processing to the print head cartridge H1000 which has moved to a home position by the carriage M4001.

By referring to FIG. 5B, the print head cartridge H1000 is configured by the print head H1001 equipped with print elements for ejection and a plurality of ink tanks H1900 installed herein. The print head H1001 is provided with print element lines corresponding to a plurality of ink colors and ink is supplied from the respective ink tanks H1900 to the print element lines corresponding thereto. The print head H1001 in the present embodiment is configured such that ink of four colors of black, cyan, magenta and yellow is used and dots of three steps composed of large, intermediate and small sizes for each color are printable.

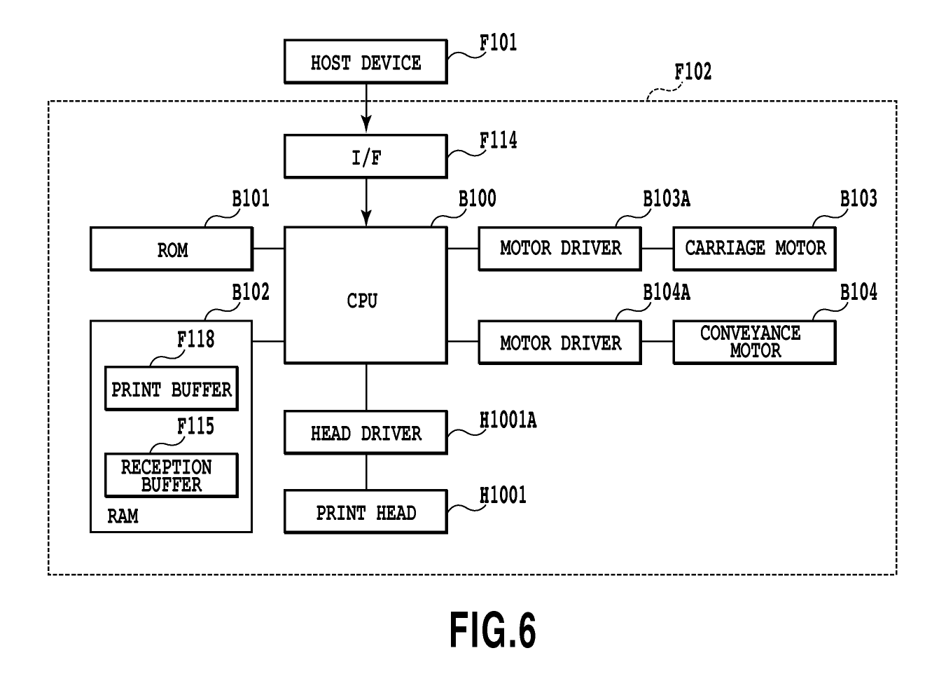

FIG. 6 is a schematic diagram explaining an arrangement of a control system in the image processor of the present embodiment. The image processor in the present embodiment is configured mainly by a printer F102 and a host device F101 connected herein, and transmission/reception of image data from the host device F101 to the printer F102 is performed via an interface (I/F) F114.

A CPU B100 performs an operation control of the entire printer, the image data processing and the like by using a RAM B102 as a work area, according to various programs and parameters stored in a ROM B101. For example, the CPU B100 temporarily stores the image data received from the host device F101 in a reception buffer F115 of the RAM B102 and performs a series of the image processing using various parameters stored in the ROM B101. Error diffusion processing specific to the present invention to be described later is also included as one process among such image processing.

The image data to which a series of the image processing is performed is stored in a print buffer F118 in the RAM B102 and is transferred to a head driver H1001A with progress of a print operation of the print head H1001. The head driver H1001A drives the print head H1001 based upon the received print signal. Ejection of ink from the print head H1001 is made by supplying a drive data (print data) and a drive control signal (heat pulse signal) of an electrothermal transducing element or the like to the head driver H1001A by the CPU B100. The CPU B100 performs an ejection operation of the print head H1001 and also drives a carriage motor B103 via a carriage motor driver B103A to move the carriage M9001 at a predetermined speed. In consequence, a printing scan is performed one time. When one time of the printing scan is completed, the CPU B100 drives the conveyance motor B104 through the conveyance motor driver B104A to rotate the conveyance roller M3001, thereby conveying a print medium by a predetermined amount (sub scan). With alternate repetition of the printing scan and the sub scan, it is possible to print the image received from the host device F101 on the print medium.

Hereinafter, the error diffusion processing method specific in the present invention performed by the CPU B100 using the aforementioned image processor will be specifically explained with reference to a plurality of embodiments.

### Embodiment 1

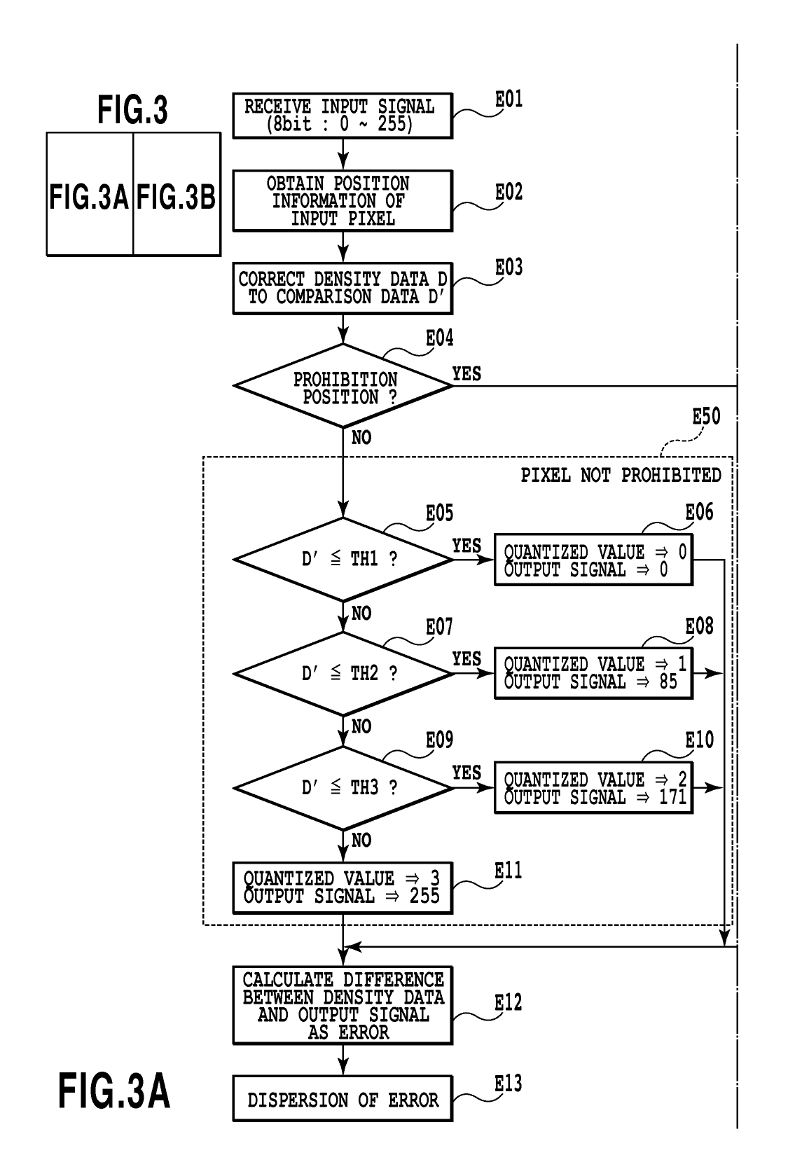

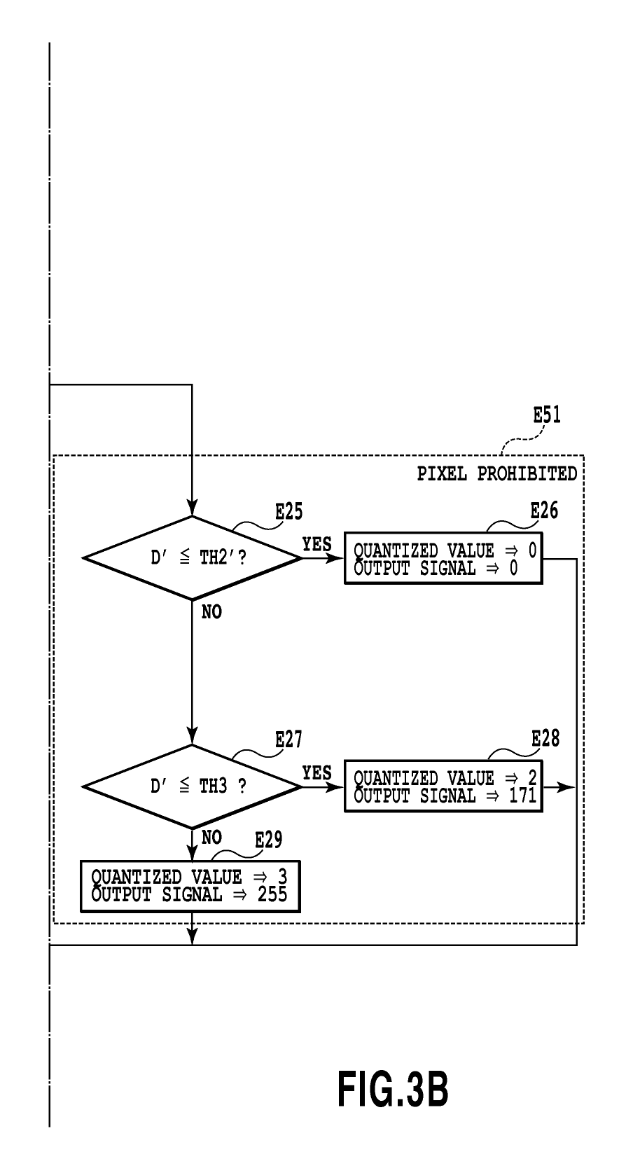

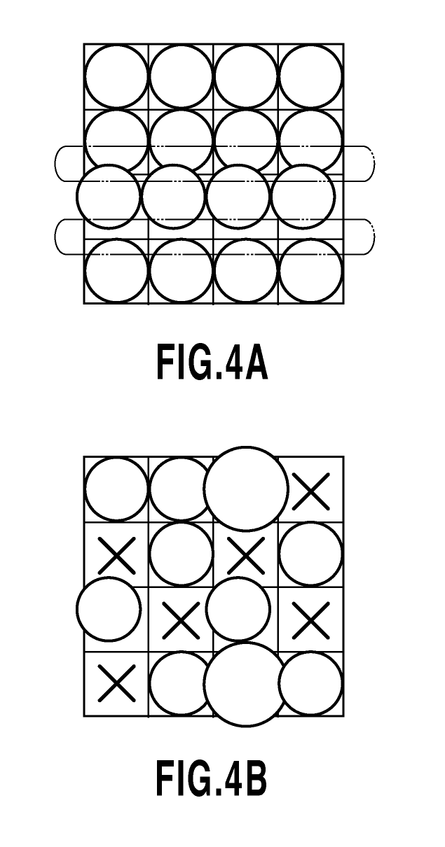

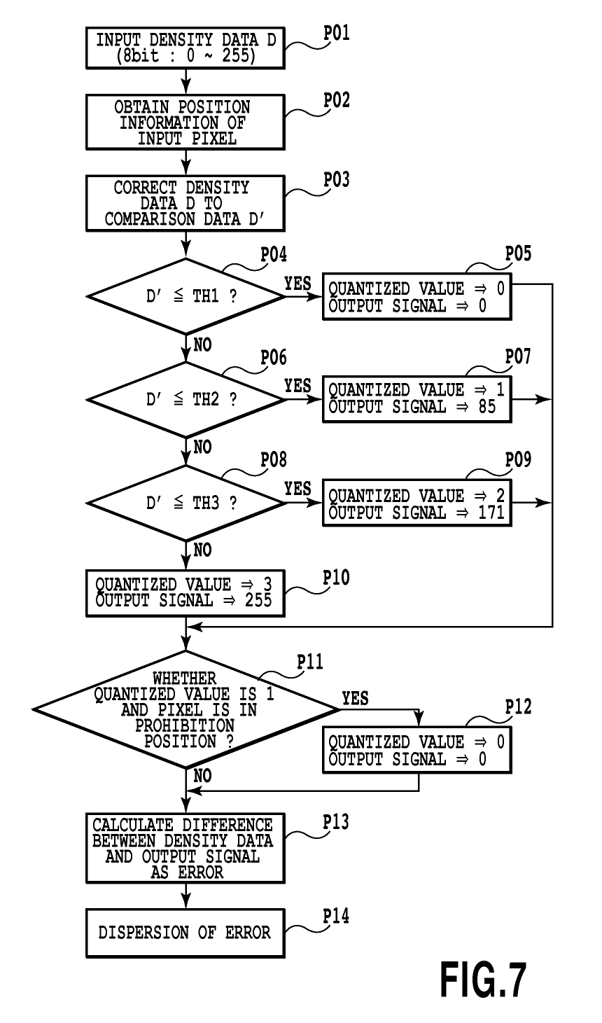

FIG. 7 is a diagram explaining the process of the error diffusion processing performed in Embodiment 1 of the present invention while comparing with the flow chart in FIG. 3 explained in Japanese Patent Laid-Open No. 2004-326613.

In regard to one pixel, density data D of 256 gradations are inputted and received in P01, position information of the pixel is obtained in P02, and in P03, the density data D are corrected to comparison data D′ by adding errors generated in the adjacent pixels. Thereafter, in P04 to P12, the quantization processing specific in the present embodiment is performed to the comparison data D′ to be converted into quantized values of four level gradations smaller than 256 gradations.

In the quantization processing of the present embodiment, three threshold values of TH1<TH2<TH3 are prepared. First, the comparison data D′ is compared with TH1 in P04. When D′≦TH1, the process goes to P05, wherein the quantized value of the pixel is set as 0. In addition, the density value of 0 in the 256 gradations corresponding to the quantized value of 0 is generated as an output signal, and the process goes to P11. On the other hand, when in P04 it is determined that D′>TH1, the process goes to P06.

The comparison data D′ is compared with TH2 in P06. When D′≦TH2, the process goes to P07, wherein the quantized value of the pixel is set as 1. In addition, the density value of 85 in the 256 gradations corresponding to the quantized value of 1 is generated as an output signal, and the process goes to P11. On the other hand, when in P06 it is determined that D′>TH2, the process goes to P08.

The comparison data D′ is compared with TH3 in P08. When D′≦TH3, the process goes to P09, wherein the quantized value of the pixel is set as 2. In addition, the density value of 171 in the 256 gradations corresponding to the quantized value of 2 is generated as an output signal, and the process goes to P11. On the other hand, when in P08 it is determined that D′>TH3, the process goes to P10.

In P10, the quantized value of the pixel is set as 3. In addition, the density value of 255 in the 256 gradations corresponding to the quantized value of 3 is generated as an output signal, and the process goes to P11.

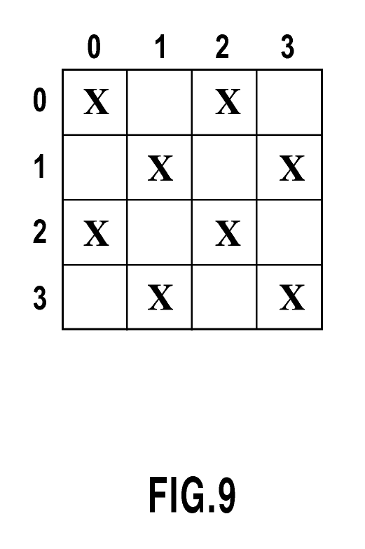

In P11 it is determined whether or not “the pixel of interest in the middle of being presently processed is in the prohibition position and the quantized value is 1”. The prohibition position may be in advance determined as shown in an X mark of FIG. 9, for example, and a coordinate in a raster direction (longitudinal direction) and in a column direction of the pixel of interest obtained in P02 can be compared with the information of the prohibition position in advance stored in the ROM B0101 to determine whether or not the pixel of interest is in the prohibition position. It is determined whether or not the quantized value is 1 based upon the quantized values obtained in the quantization processing performed in P04 to P10. When it is determined that the pixel of interest is “in the prohibition position and the quantized value is 1”, the process goes to P12, and when it is not determined in such a way, the process goes to P13.

A change of each of the quantized value and the output signal is made to the pixel in which it is determined that the pixel of interest is in the prohibition position and the quantized value is 1. Specifically the quantized value of the pixel is changed from 1 to 0 and output signal is changed from 85 to 0. Thereafter, the process goes to P13.

In P13, in regard to the pixel of interest, a difference (error) between the density data D inputted and obtained in P01 and the output signal obtained in the above quantization processing is calculated. In P14, the error calculated in P13 is diffused to unprocessed pixels according to a predetermined diffusion coefficient. As a result, the present processing ends.

In a case where the quantization processing is performed in the above flow chart, in regard to the prohibition position, by prohibiting the quantized value to be 1, the quantized value is forcibly made to 0, but the error generated herein is stored (P12 and P13). That is, the prohibition position of the present embodiment serves such that the density value in the pixel is accumulated, which is diffused to other pixels to increase the quantized value at other pixel positions. As a result, as similar to the case of Japanese Patent Laid-Open No. 2004-326613 described above, even if the density value has a low level, since intermediate dots are printed in places among the small dots, an image degradation such as “dot delay”, “banding” or “wind ripple” can be restricted.

However, as seen from a comparison between the flow chart in FIGS. 3A and 3B and the flow chart in FIG. 7, the present embodiment does not provide two of quantization processing such as E50 and E51 that are performed in parallel. After one quantization processing explained in P04 to P10 is performed, the changing processing is performed simply in P11 and in P12. Therefore, it is not necessary to prepare the two kinds of the circuit arrangements for quantization processing as in the case of Japanese Patent Laid-Open No. 2009-326613.

In addition, according to the present embodiment, the memory capacity for storing the threshold values (TH1 to TH3) necessary for the quantization can be also restricted to be smaller as compared to Japanese Patent Laid-Open No. 2004-326613.

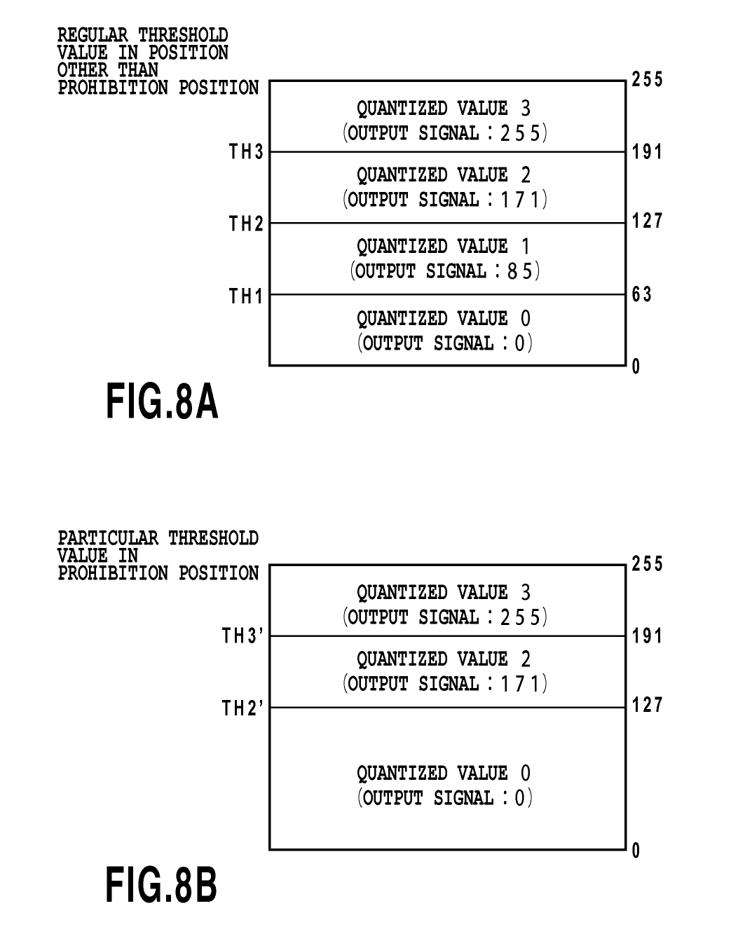

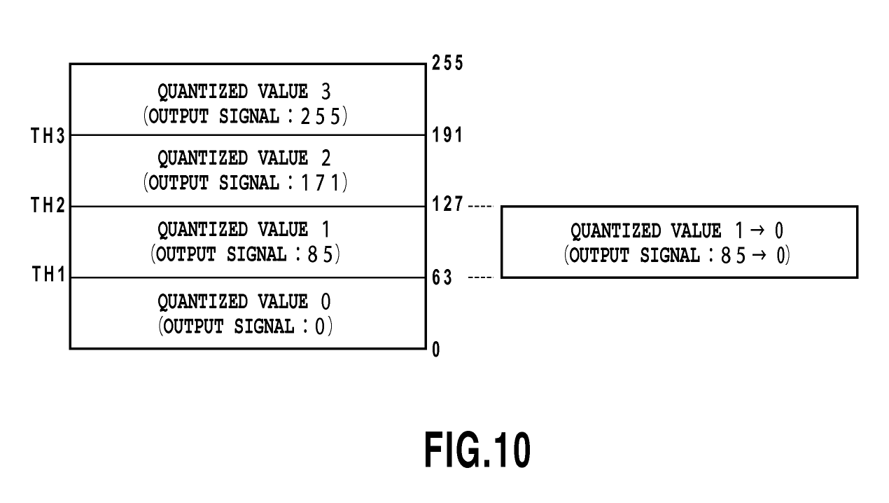

FIG. 10 is a diagram explaining threshold values prepared in the present embodiment by comparing with threshold values prepared in Japanese Patent Laid-Open No. 2004-326613 shown in FIG. 8A and in FIG. 8B. According to the method of Japanese Patent Laid-Open No. 2004-326613, three threshold values of TH1 to TH3 as shown in FIG. 8A, the four quantized values and the four-output level information, that are defined by a magnitude relation between the threshold values and the comparison data D′, are prepared for the first quantization processing E50. Further, two threshold values of TH3′ and TH2′ as shown in FIG. 8B, the three quantized values and the three-output level information, that are defined by a magnitude relation between the two threshold values and the comparison data D′, are prepared for the second quantization processing E51. On the other hand, according to the method of the present embodiment, as shown in FIG. 10, it is only required to prepare correction information for the prohibition position in addition to the information of general quantization processing. That is, by adopting the present embodiment, it is possible to cut down on the memory capacity necessary for the quantization processing including the threshold values as compared to Japanese Patent Laid-Open No. 2004-326613.

As explained above, according to the present embodiment, it is possible to obtain the effect similar to Japanese Patent Laid-Open No. 2004-326613 in terms of image quality and also restrict the cost as compared to Japanese Patent Laid-Open No. 2004-326613.

### Embodiment 2

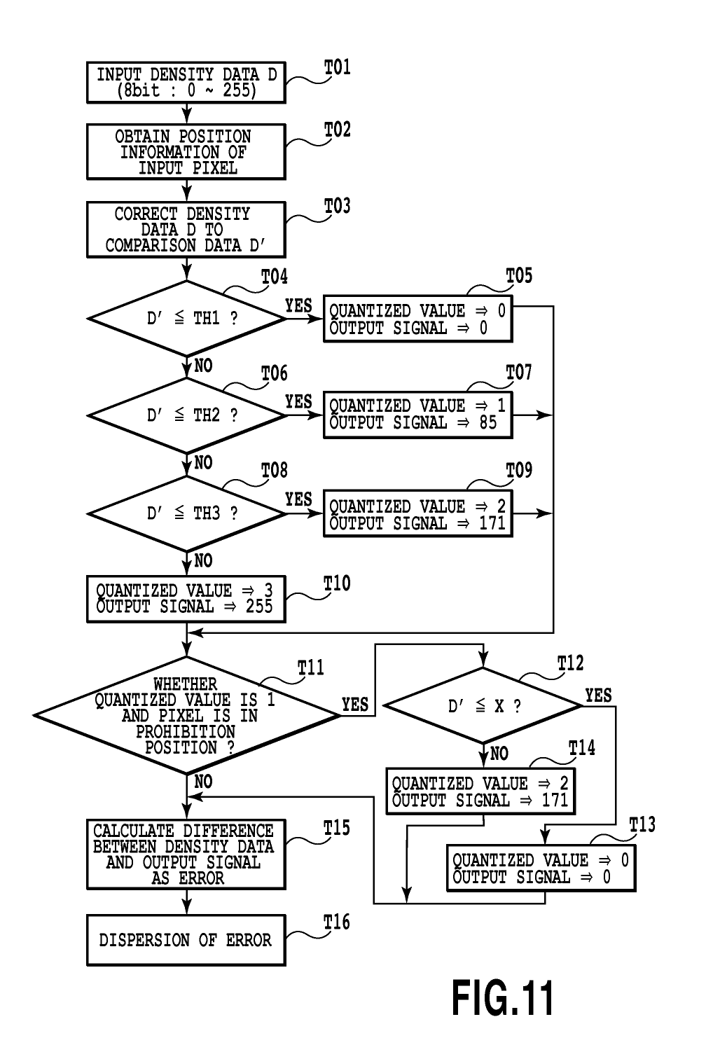

FIG. 11 is a flow chart explaining the process of error diffusion processing performed in Embodiment 2 of the present invention by comparing with Japanese Patent Laid-Open No. 2004-326613 and Embodiment 1. In the present embodiment, the processing from T01 to T07, that is, the process until the general quantization processing is the same as in Embodiment 1 explained in FIG. 7. That is, the three threshold values TH1 to TH3 in advance prepared are compared with the comparison data D′ to obtain the quantized value of any of 0 to 3 and the output signal of the 256 gradations corresponding to each quantized value. Hereinafter, the process after T11 will be explained.

In T11 it is determined whether or not “the pixel of interest in the middle of being presently processed is in the prohibition position and the quantized value is 1”. The prohibition position may be in advance determined as shown in the X mark of FIG. 9 in the same way as Embodiment 1. When it is determined that the pixel of interest is “in the prohibition position and the quantized value is 1”, the process goes to T12, and when it is not determined in such a way, the process goes to T15.

A change of each of the quantized value and the output signal is made to the pixel in which it is determined that the pixel of interest is in the prohibition position and the quantized value is 1. Specifically the density value D′ of the pixel before the quantization is again compared with a new threshold value X (TH1<X<TH2). When D′≦X, the process goes to T13, wherein the quantized value of the pixel is changed from 1 to 0, and the output signal is changed from 85 to 0. On the other hand, when D′>X, the process goes to T14, wherein the quantized value of the pixel is changed from 1 to 2, and the output signal is changed from 85 to 171. Thereafter, the process goes to T15.

In T15, in regard to the pixel of interest, a difference (error) between the density data D inputted and obtained in T01 and the output signal obtained in the above quantization processing is calculated. In T16, the error calculated in T15 is diffused to unprocessed pixels according to a predetermined diffusion coefficient. As a result, the present processing ends.

In a case where the quantization processing is performed in the above flow chart, in regard to the prohibition position, by prohibiting the quantized value to be 1, the quantized value is forcibly changed to 0 or 2, but the error generated herein is stored (T13 to T15). That is, the prohibition position in the present embodiment serves such that when the density value is lower than the threshold value X, the density value in the pixel is accumulated, which is diffused to other pixels to increase the quantized value at other pixel positions. When the density value is higher than the threshold value X, the density value in the pixel is increased to print larger dots, diffusing the density value (minus density value) corresponding to an amount consumed to other pixels. As a result, as similar to the case of Japanese Patent Laid-Open No. 2004-326613 described above, even if the density value has a low level, since intermediate dots are positively printed among the small dots, the image degradations such as “dot delay”, “banding” and “wind ripple” can be restricted.

In the present embodiment also, in the same way as Embodiment 1, it is not necessary to prepare the two kinds of the circuit arrangements for the quantization processing and it is also possible to cut down on the memory capacity for storing the threshold values necessary for the quantization as compared to the case of Japanese Patent Laid-Open No. 2004-326613.

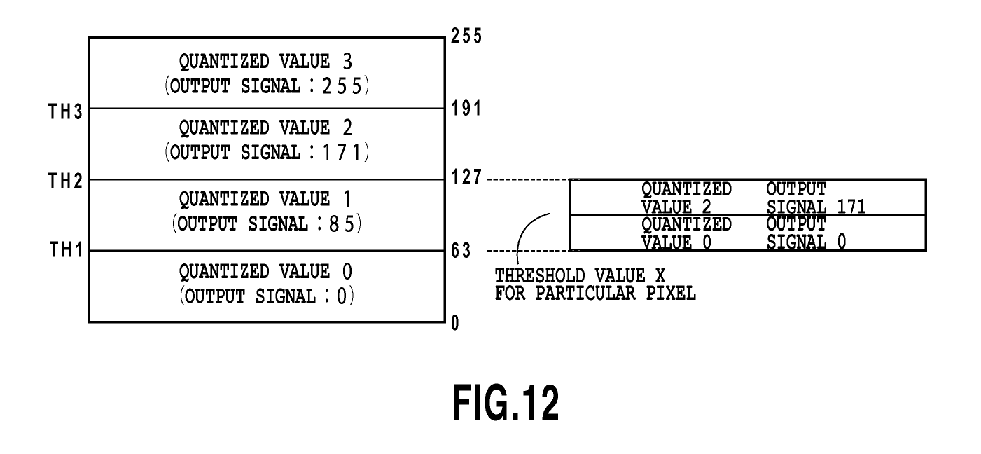

FIG. 12 is a diagram explaining threshold values prepared in the present embodiment by comparing with Japanese Patent Laid-Open No. 2004-326613. According to the method of the present embodiment, it is only required to prepare three threshold values TH1 to TH3 for quantization processing, a threshold value X for once more quantizing the density information in the prohibition position and output signal information corresponding to each quantized value. That is, according to the adoption of the present embodiment, it is possible to cut down on the memory capacity for securing the threshold value as compared to Japanese Patent Laid-Open No. 2004-326613.

Further, according to Embodiment 1, in a case where the pixel of interest is “in the prohibition position and the quantized value is 1”, the quantized value of the pixel is fixed to 0, but in the present embodiment, the quantized value is allotted to any of 0 and 2. Therefore, in the present embodiment, the dot is easier to enter into the prohibition position than in Embodiment 1, and a dot arrangement state with high dispersibility can be obtained to expect a high-quality image with restricted granularity.

It should be noted that the threshold value X for the prohibition position may be prepared independently of other threshold values or output signals, but may divert from the output signal (85) in the quantized value of 1. The diversion of the output signal value enables the number of resistors for storing the value to be reduced by one.

As explained above, according to the present embodiment, it is possible to obtain the effect similar to or more than that of Japanese Patent Laid-Open No. 2004-326613 in terms of image quality and also restrict the cost as compared to Japanese Patent Laid-Open No. 2004-326613.

### Embodiment 3

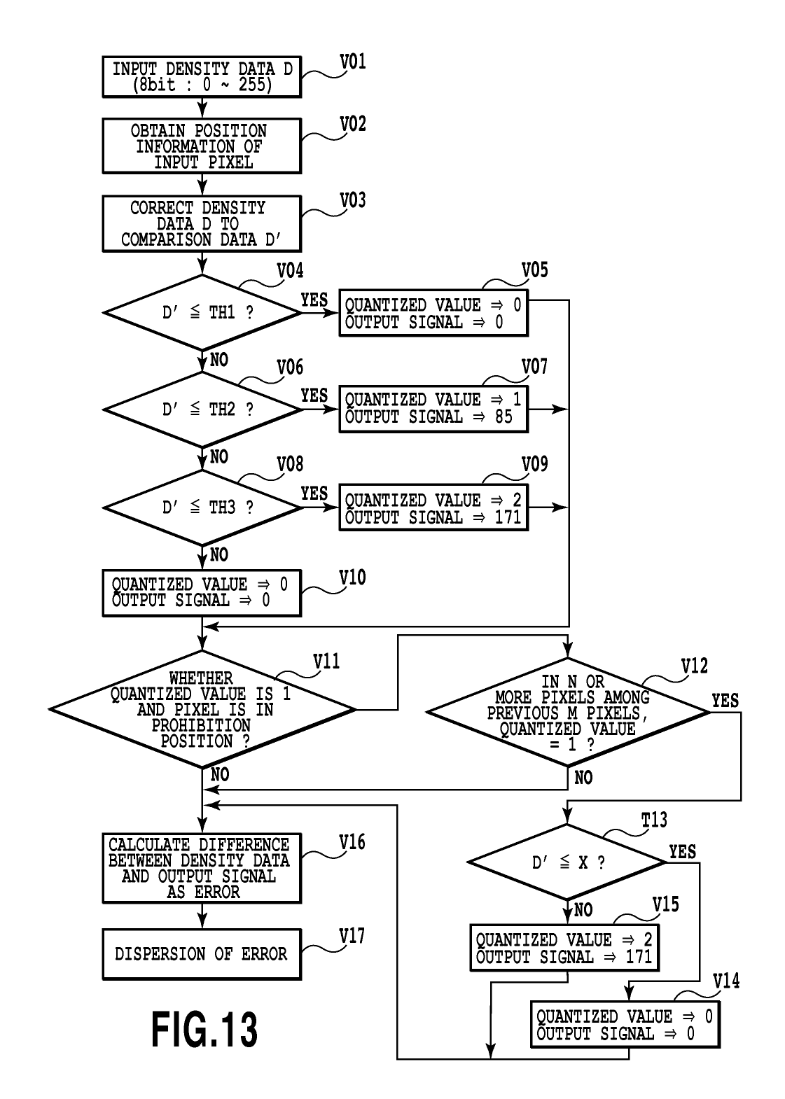

FIG. 13 is a flow chart explaining the process of error diffusion processing performed in the present embodiment by comparing with Japanese Patent Laid-Open No. 2004-326613 and the above embodiment. In the present embodiment, the processing from V01 to V10, that is, the process until the general quantization processing is the same as the above embodiment. That is, the three threshold values TH1 to TH3 in advance prepared are compared with the comparison data D′ to obtain the quantized value of any of 0 to 3 and the output signal of the 256 gradations corresponding to each quantized value. Hereinafter, the process after V11 will be explained.

In V11 it is determined whether or not the pixel of interest in the middle of being presently processed is “in the prohibition position and the quantized value is 1”. The prohibition position is in advance determined as shown in the X mark of FIG. 9 in the same way as Embodiment 1. When it is determined that the pixel of interest is “in the prohibition position and the quantized value is 1”, the process goes to V12, and when it is not determined in such a way, the process goes to V16.

In V12 to V15, a change of each of the quantized value and the output signal is made to the pixel in which it is determined that the pixel of interest is in the prohibition position and the quantized value is 1. Specifically by referring to quantized values of m pieces of pixels already processed before processing the corresponding pixel, in a case where each quantized value of n or more pieces of the pixels is 1, the process goes to V13, and in a case where each quantized value of n or more pieces of the pixels is not 1, the process goes to V16. In V13 to V15, the quantization processing similar to that of Embodiment 2 is performed, and the process goes to T16.

In V16, in regard to the pixel of interest, a difference (error) between the density data D inputted and obtained in V01 and the output signal obtained in the above quantization processing is calculated. In V17, the error calculated in V16 is diffused to unprocessed pixels according to a predetermined diffusion coefficient. As a result, the present processing ends.

In a case where the quantization processing is performed in the above flow chart, in regard to the prohibition position, necessity of a change in the quantized value is determined corresponding to the quantization result of the adjacent pixels already processed. That is, in a case where among the already processed adjacent pixels, a majority of the pixels each have the quantized value of 1, the processing (V13 to V15) for changing into the quantized value of another level is performed. On the other hand, in a case where among the already processed adjacent pixels, a minority of the pixels each have the quantized value of 1, it is determined that the quantized value of the pixel of interest may be 1 as it is. In this way, according to the present embodiment, the quantized value of 1 is not necessarily prohibited in the prohibition position, but necessity of the quantized value of 1 is determined based upon the distribution of the quantized value of 1 in the adjacent pixels.

When such quantization method in the present embodiment is adopted, it is possible to obtain a more preferable distribution of dots (small dots) defined in the quantized value of 1 as compared to Japanese Patent Laid-Open No. 2004-326613 or the aforementioned embodiment.

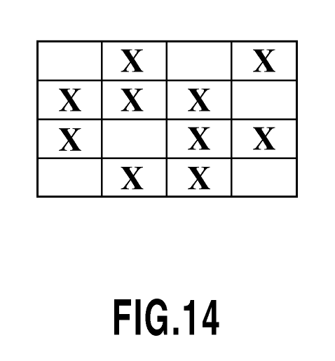

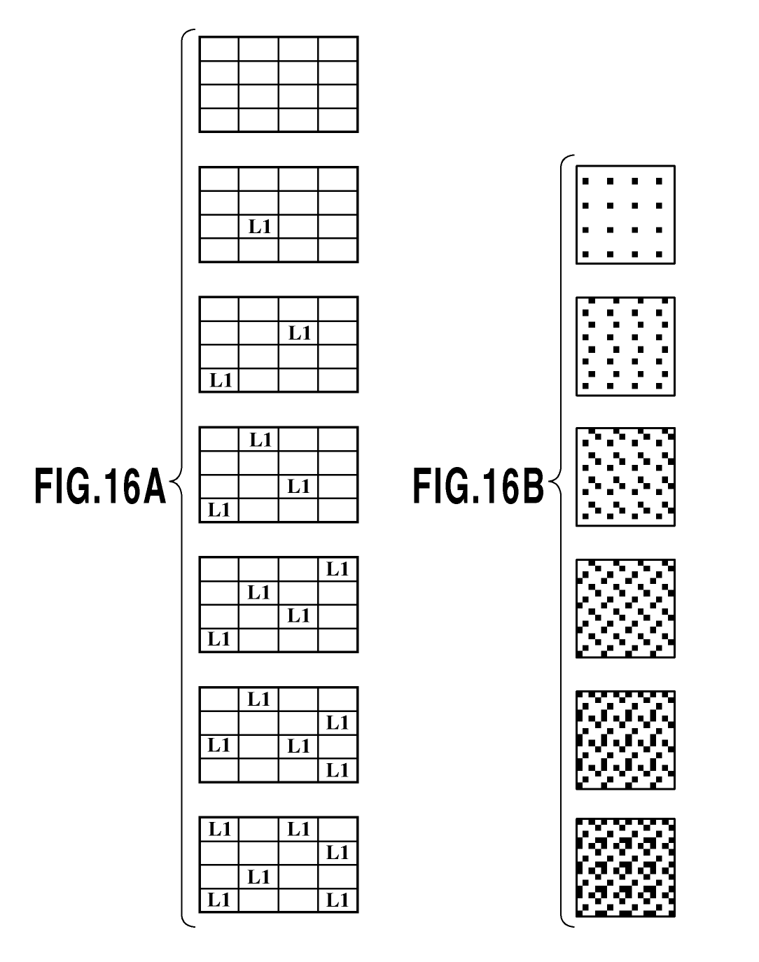

FIG. 16A and FIG. 16B are diagrams explaining states of a distribution of pixels defined in the quantized value of 1 and a distribution of small dots at the time of gradually increasing the density from a highlight in a case of performing the error diffusion processing with the method of Japanese Patent Laid-Open No. 2004-326613 based upon the prohibition position shown in FIG. 14. Since the prohibition position is fixed to the X position in FIG. 14, the dot is not printed in the prohibition position even in the highlight portion, and the dot is gradually printed in pixels in positions other than the prohibition position. In this case, the second or third printed dot is not necessarily printed in a state of higher dispersibility with respect to the first printed dot. Therefore, when the printing state of the dot is confirmed in a relatively wide range, there are, as shown in FIG. 16B, some cases where the feature of the pattern defining the prohibition position can be confirmed and the dispersibility of the dot is low in places, so that granularity or texture stands out.

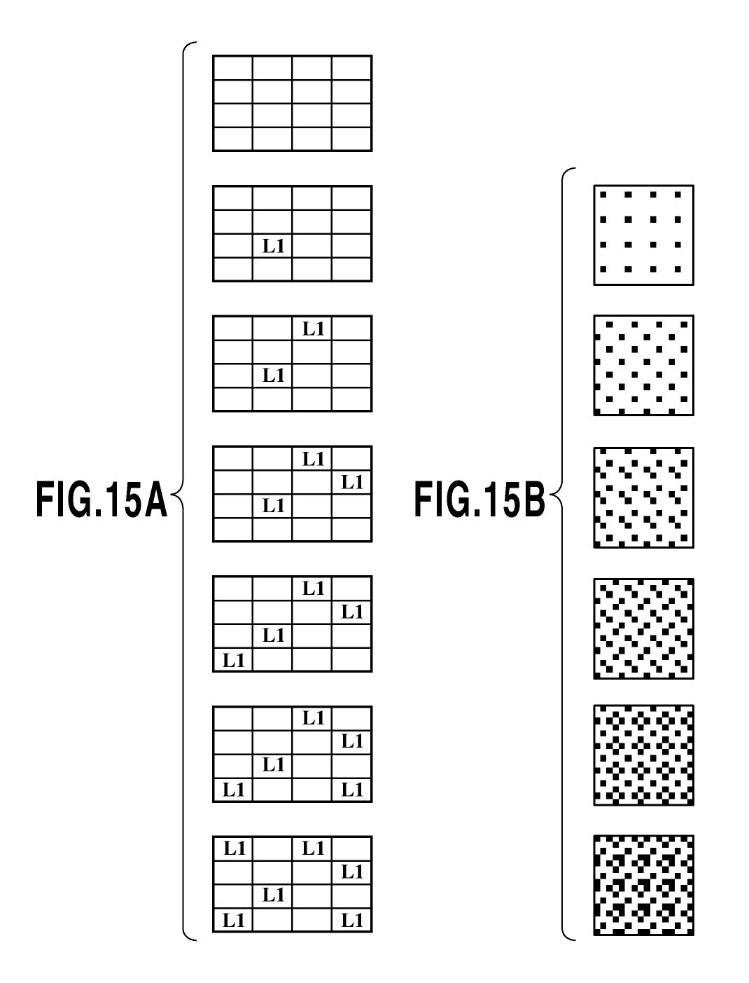

On the other hand, FIG. 15A and FIG. 15B are diagrams showing a distribution of pixels defined in the quantized value of 1 and a distribution of small dots in the same way as in FIG. 16A and in FIG. 16B in a case of performing the error diffusion processing with the method in the present embodiment using the prohibition position shown in FIG. 14. In a case of the present embodiment, when the number of the adjacent dots is small as in the highlight portion, the dot is printed even in the prohibition position. Therefore, dots to be added are also printed in a state of high dispersibility with respect to other dots. In consequence, by referring to FIG. 15B, when the printing state of the dot is confirmed in a relatively wide range, it is possible to realize an image which has higher dot dispersibility and in which granularity or texture is restricted as compared to FIG. 16B.

As a result, the present embodiment can realize output of a smoother image having further smaller granularity than the above embodiment, at a lower cost as compared with Japanese Patent Laid-Open No. 2004-326613 while restricting image degradations such as “dot delay”, “banding” and “wind ripple”.

### Embodiment 4

There is known a multipass printing system as a method for making ejection variations between print elements not stand out. In the multipass printing system, the print head performs plural times (M times) of printing scans on the same region of the print medium to step by step form an image. Therefore, in performing this multipass printing system, it is necessary to divide the image data into M pieces of data corresponding to M times of the printing scans. For example, Japanese Patent Laid-Open No. 2000-103088 discloses a method in which the image data is divided to correspond to plural printing scans in a state of the multi-valued image data before binarization and each of the divided multi-valued image data is binarized independently from each other (without correlation).

When a print is performed based upon the binarized data by each of the plural printing scans by adopting Japanese Patent Laid-Open No. 2000-103088, there are in places generated locations where dots overlap for printing. In this case, even if a print position is shifted between printing scans due to any cause, since locations where dots newly overlap and locations where the overlapped dots are separated exist to be mixed with each other, a dot coverage rate in a predetermined region does not change so much. That is, when Japanese Patent Laid-Open No. 2000-103088 is adopted, even if the print position shift between the printing scans is generated in performing a multipass print, it is possible to restrict density variations due to the print position shift.

However, in the method described in Japanese Patent Laid-Open No. 2000-103088, “dot delay” or “wind ripple” is possibly rather emphasized in view of the problem to be solved by the present invention. This is because the density value which is quantized into an intermediate dot or a large dot unless the image data is divided in a stage of the multi-valued data, will be divided into reduced density values corresponding to plural printing scans and a use frequency of small dots will increase.

However, even in a case of performing the multipass print adopted in such Japanese Patent Laid-Open No. 2000-103088, the present invention can be effectively functioned.

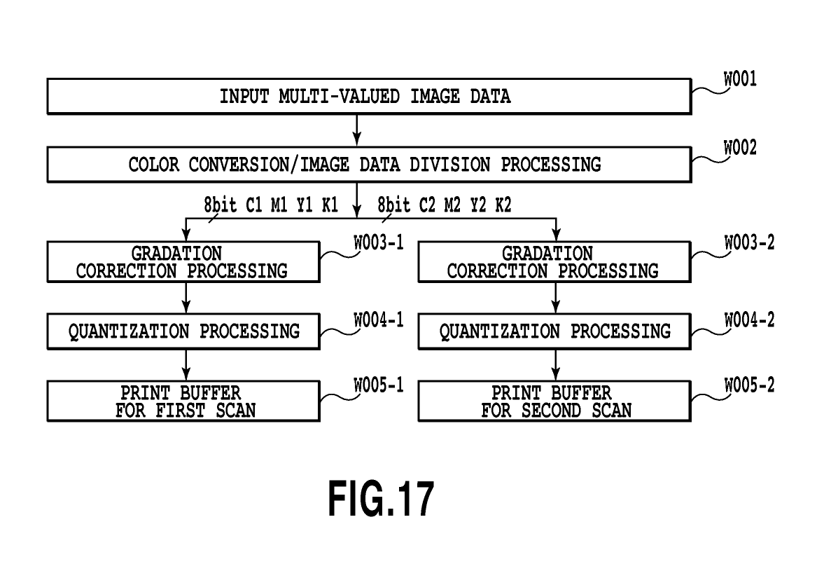

FIG. 17 is a block diagram explaining the process in the image processing performed in the present embodiment. The error diffusion processing of each of the aforementioned embodiments can correspond to the quantization processing shown in W004-1 and W004-2. In FIG. 17, a multi-valued data inputted into each pixel of the printer is generally color information of RGB and in color conversion/image data division processing W002, the multi-valued data is converted into a first multi-valued density data and a second multi-valued density data. Specifically a three-dimensional lookup table (LUT), in which RGB values of the multi-value are one by one associated with CMYK values corresponding to ink colors used in the printer, is referred to. In consequence, the inputted RGB data are converted at once into multi-valued density data (C1, M1, Y1 and K1) for first printing scan and multi-valued density data (C, M2, Y2 and K2) for second printing scan. At this time, the converted value of (C1, M1, Y1 or K1) and (C, M2, Y2 or K2) are value (about half the value) smaller than that in a case of converting the RGB data into CMYK as they are.

Thereafter, one-dimensional gradation correction processing is performed to each of the multi-valued density data by gradation correction processing W003-1 or W003-2, and further, each of the error diffusion processing W004-1 and W004-2 is performed to the density data. At this time, the error diffusion processing can be adopted in any of the aforementioned embodiments. However, in order that positions of pixels where dots are printed are appropriately different between twice of printing scans, it is preferable that different diffusion coefficients are adopted in two of the error diffusion processing W004-1 and W009-2. When the quantized values of 1 to 3 are defined by the above error diffusion processing, these data are stored respectively in each of regions W005-1 and W005-2 prepared corresponding to each printing scan in the print buffer F118 and are printed with dots each having the corresponding size by the corresponding printing scan.

According to the present embodiment explained above, even in a case of adopting the multipass printing method used in Japanese Patent Laid-Open No. 2000-103088, since intermediate dots and large dots can be appropriately mixed from the low density level for printing, it is possible to avoid a situation where the print is performed only by small dots. As a result, it is possible to output, by the multipass print, a high-quality image which has a strong resistance to density variations due to the print position shift between printing scans and in which degradations such as “dot delay”, “banding” and “wind ripple” are restricted. At this time, particularly as in the case of Embodiment 3, by determining the quantized value of the pixel of interest based upon the result of the quantized values of the adjacent pixels in the pixel of interest, it is possible to restrict also moire generated due to synchronization between printing scans, in addition to “dot delay”, “banding” and “wind ripple” described above.

Incidentally, for simplifying the explanation in the above description, there is explained the construction that the RGB data of the multi-value is converted into two multi-valued density data by taking a case of the multipass print of two-passes an example, but the present embodiment may be adopted to the multipass printing having many more multipass number. Since an increase in the multipass number leads to an increase in a use rate of small dots, it is possible to more effectively carry out the present invention.

### Other Embodiment

The above embodiment explains an example in which the quantized value of the pixel in the prohibition position, of which the quantized value is 1, is changed and the intermediate dot is ahead printed in the highlight portion which is mainly printed only by the small dot. However, the effect of the present invention is not limited to such gradation region. For example, it is possible that the prohibition position for the intermediate dot is provided and the processing of correcting the quantized value is performed only to the pixel which is in the prohibition position and in which the quantized value is 2. That is, if a region has the density level as much as the quantized value changes, the present invention can be effectively carried out in any region and the effect of the present invention can be effectively achieved in plural-density regions where the quantized value changes.

In the three embodiments as described above, there is explained the construction that the pattern as shown in FIG. 14 is in advance stored in the memory and the prohibition position is defined using this pattern, but an indication of the prohibition position may be found by a calculation or the like. For example, a position (Y) of the pixel of interest in the raster direction and a position (X) of the pixel in the column direction may be used to determine that a position where a remainder of (X+Y)/2 is 0 is the prohibition position and a position where the remainder is 1 is not the prohibition position. In a case of storing the prohibition positions with the pattern as shown in FIG. 14, it is possible to define a size of the pattern and an arrangement of the prohibition positions in large degrees of freedom. On the other hand, in a case of finding the prohibition position by a calculation, it is not necessary to additionally provide a memory necessary for the pattern.

The above embodiment explains an example in which the inkjet printer for printing dots having different sizes of large, intermediate and small is used. Additionally the pixel having the quantized value of 1 is defined as a pixel to which a small dot is printed, the pixel having the quantized value of 2 is defined as a pixel to which an intermediate dot is printed, and the pixel having the quantized value of 3 is defined as a pixel to which a large dot is printed. However, since the present invention serves to limit the quantized value in a particular pixel position (prohibition position), a relation between the quantized value and the dot is not limited to the construction described in the above embodiment. For example, plural kinds of dot each having the same size and different density may be used to define the quantized value of 1 as low density ink, the quantized value of 2 as intermediate density ink and the quantized value of 3 as high density ink. In addition, in the inkjet printer for printing only dots each having the same size and the same density, the quantized value may be associated with the number of dots printed in one pixel such that the quantized value of 1 corresponds to one dot, the quantized value of 2 corresponds to two dots and the quantized value of 3 corresponds to three dots. Further, in the inkjet printer for performing a print using three kinds of dots of large, intermediate and small sizes to one pixel as in the case of the above embodiment, furthermore kinds of dots may be printed on the same pixel.

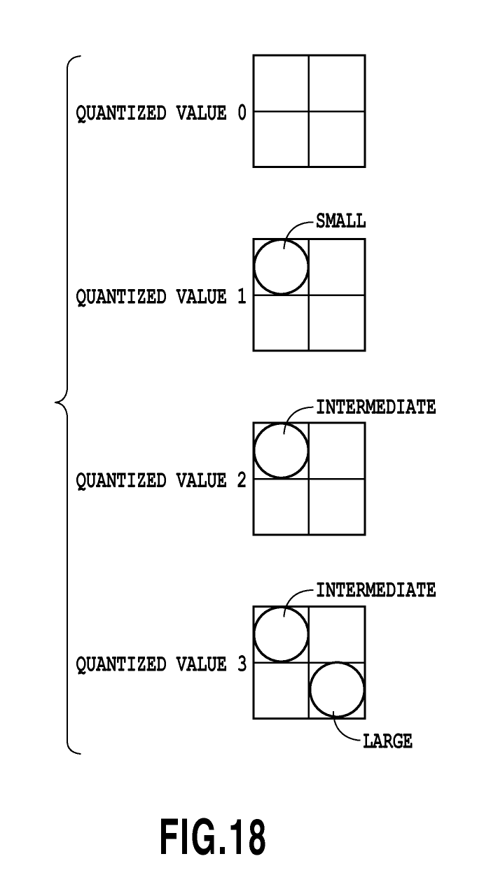

FIG. 18 is diagrams showing an example in which the present invention is applied to a printing system for associating pixels of 2×2 with one quantized value. In the figure, in a case of the quantized value of 0, the dot is not printed in any of the pixels of 2×2, in a case of the quantized value of 1, one small dot is printed in the pixel on the left top, in a case of the quantized value of 2, one intermediate dot is printed in the pixel on the left top, and in a case of the quantized value of 3, one intermediate dot is printed in the pixel on the left top and one large dot is printed in the pixel on the right bottom. Even in such printing system, as the quantized value increases, the density expressed in the pixels of 2×2 is higher. When any of the aforementioned embodiments is adopted, that is, when the quantized value of 1 is limited to print the quantized value of 2 with priority, intermediate dots are appropriately mixed from the low density level, and therefore it is possible to avoid the situation where only small dots are printed.

In addition, the aforementioned embodiment explains an example of the inkjet printer using ink of four colors and printing dots of large, intermediate and small sizes in regard to one color, but the present invention is not limited thereto. In regard to the quantized value, at least three steps (the quantized values of 0 to 2) including 0 are only required to be prepared, and the color number of ink or the quantized value may be prepared furthermore. In addition, the quantized value or the arrangement of the prohibition positions may differ for each ink color, each print medium or each set print mode, and presence/absence of adoption of the present invention may be switched in the same way as the above. Particularly making the prohibition position differ for each ink color is effective also in view of avoidance of synchronization between images printed in respective colors. Further, limiting a condition, to which the present invention, is effective for reducing the circuit scale, the memory capacity and calculation time that tend to increase due to the adoption of the present invention. In any case, at the time of quantizing the density data of an L value to a K value (3≦K<L) in at least one ink color, the above embodiment can be applied such that a predetermined value among the K value is limited to be changed into another quantized value in a particular pixel position (prohibition position).

Further, the above embodiment explains the image processor performing the featuring image processing of the present invention by taking the printer F102 having the image processing function as an example, but the present invention is not limited to such construction. The present invention may be configured such that the featuring image processing of the present invention is performed by a host device (for example, F101 in FIG. 6) in which a printer driver is installed and the quantized image data is inputted to the printer. In this case, the host device (external device) connected to the printer corresponds to the image processor in the present invention. In addition, such host device is not necessarily a computer device, but may be an image input/output device such as a digital camera.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-261910, filed Nov. 17, 2009, which is hereby incorporated by reference herein in its entirety.

What is claimed is:

1. An image processor for quantizing a density data of L-value of a pixel of interest to a quantized value of K-value (3≦K<L) to print dots on a print medium based upon the quantized value, comprising:
a unit configured to obtain the density data of L-value corresponding to the pixel of interest;
a unit configured to correct the density data of L-value to a comparison data of L-value using an error diffused from a pixel which is adjacent to the pixel of interest and is already quantized;
a unit configured to obtain position information of the pixel of interest;
a quantization unit configured to convert the comparison data of L-value into the quantized value of K-value based upon the result by comparison with plural threshold values and generate an output signal of L-value corresponding to the quantized value;
a determining unit configured to determine whether or not the quantized value is changed based upon the quantized value and the position information of the pixel of interest;
a changing unit configured to, when the determining unit determines to change the quantized value, change the quantized value and change the output signal of L-value corresponding to the changed quantized value; and
a unit configured to diffuse an error between the density data of L-value and the output signal of L-value in the pixel of interest to a pixel which is adjacent to the pixel of interest and is not yet converted by the quantization unit.

2. An image processor according to claim 1, wherein the determining unit determines to change the quantized value in a case where the quantized value is a predetermined value and the pixel of interest is in a prohibition position.

3. An image processor according to claim 2, wherein the prohibition position is defined by a pattern in advance stored.

4. An image processor according to claim 2, wherein the prohibition position is calculated from the position information of the pixel of interest.

5. An image processor according to claim 2, wherein the changing unit changes the quantized value to a value having a level lower than the predetermined value.

6. An image processor according to claim 2, wherein the changing unit changes the quantized value based upon the result found by comparing another threshold value different from the threshold value with the comparison data.

7. An image processor according to claim 1, wherein the determining unit determines whether or not the quantized value is changed based upon the quantized value, the position information of the pixel of interest, and quantized values of plural pixels which are adjacent to the pixel of interest and are already quantized.

8. An image processor according to claim 1, wherein the image processor, for making a print head for printing the dots on the print medium based upon the quantized value perform printing scan over the same image region of the print medium by M times to print an image, generates the quantized value used for the printing in each of M times of the printing scans, further comprising:
a unit configured to convert a multi-valued data of the pixel of interest into M pieces of the density data of L-value associated with M times of the printing scans, wherein the quantization is performed to each of the M pieces of the density data of L-value.

9. An image processor according to claim 1, wherein the quantized value corresponds to a size of the dot printed on the print medium.

10. An image processor according to claim 1, wherein the quantized value corresponds to a size and the number of the dot printed in a region of the print medium corresponding to the pixel of interest.

11. An image processing method for quantizing a density data of L-value of a pixel of interest to a quantized value of K-value (3≦K<L) to print dots on a print medium based upon the quantized value, comprising:
a step of obtaining the density data of L-value corresponding to the pixel of interest;
a step of correcting the density data of L-value to a comparison data of L-value using an error diffused from a pixel which is adjacent to the pixel of interest and is already quantized;
a step of obtaining position information of the pixel of interest;
a quantization step of converting the comparison data of L-value into the quantized value of K-value based upon the result by comparison with plural threshold values and generating an output signal of L-value corresponding to the quantized value;
a determining step of determining whether or not the quantized value is changed based upon the quantized value and the position information of the pixel of interest;
a changing step of, when the determining step determines to change the quantized value, changing the quantized value and changing the output signal of L-value corresponding to the changed quantized value; and
a step of diffusing an error between the density data of L-value and the output signal of L-value in the pixel of interest to a pixel which is adjacent to the pixel of interest and is not yet converted by the quantization step.
